(19) United States
(12) Patent Application Publication
(10) Pub. No.: US 2019/0033454 A1
(43) Pub. Date: Jan. 31, 2019

(54) LOCATING PHYSICAL DEVICES

(71) Applicant: CA, Inc., New York, NY (US)

(72) Inventor: Serge Mankovskii, Morgan Hill, CA (US)

(21) Appl. No.: 15/661,757

(22) Filed: Jul. 27, 2017

(51) Int. Cl. G01S 17/42; G01S 17/02

(52) U.S. Cl. CPC G01S 17/42; H04B 10/116; G01S 17/023

(57) ABSTRACT

Techniques are disclosed relating to determining a physical location of an item within an environment. For example, in various embodiments, a location system may determine a location of a first item of a plurality of items. In some embodiments, the location system may emit a pulse of light via a light source. The location system may receive a plurality of reflections that have been reflected from retroreflective material on one or more of the plurality of items. Further, in some embodiments, the location system may determine a direction of the location of the first item relative to a reference location. The location system may, in some embodiments, determine a distance between the reference location and the first item. Additionally, in some embodiments, the location system may determine identification information associated with the first item.

### BACKGROUND

### Technical Field

This disclosure relates generally to computing devices, and more specifically to determining physical locations of items within an environment.

### Description of the Related Art

In the operation of a physical environment, such as a warehouse or datacenter, various items may be moved throughout the environment over time. For example, tools, computer systems, or other items may be moved between locations based on the needs of a user at a particular time, rather than according to a schedule. Determining the physical location of items within a large area may therefore be burdensome in some cases. In a warehouse, for example, in which there are a large number of items belonging to various parties distributed throughout the warehouse, it may be particularly difficult to determine a physical location of an item within the environment.

### SUMMARY

Techniques are disclosed relating to determining a physical location of an item within an environment. For example, in various embodiments, a location system may determine a location of a first item of a plurality of items. In some embodiments, the location system may emit a pulse of light via a light source. The location system may receive a plurality of reflections that have been reflected from retroreflective material on one or more of the plurality of items. Further, in some embodiments, the location system may determine a direction of the location of the first item relative to a reference location. For example, in some embodiments, the location system may determine the direction based on an angle of a reflection corresponding to the first item. Further, in various embodiments, the location system may determine a distance between the reference location and the first item. Additionally, in some embodiments, the location system may determine identification information associated with the first item.

### BRIEF DESCRIPTION OF THE DRAWINGS

FIG. 1 is a block diagram illustrating an example location system for determining a physical location of an item within an environment, according to some embodiments.

FIG. 2 is a block diagram illustrating an example location system, according to some embodiments.

FIGS. 3A-3B depict block diagrams of example retroreflective patterns, according to some embodiments.

FIG. 4 is a block diagram illustrating an example location system determining a distance between an item and a reference point, according to some embodiments.

FIG. 5 is a flow diagram illustrating an example method for determining a physical location of an item within an environment, according to some embodiments.

FIGS. 6A-6B depict block diagrams of example augmented reality devices, according to some embodiments.

FIG. 7 is a block diagram illustrating a block diagram of an example augmented reality device, according to some embodiments.

FIG. 8 is a flow diagram illustrating an example method for overlaying graphic content in an augmented reality environment.

FIG. 9 is a block diagram illustrating an example computer system that may be used to implement one or more of the components in a location system, according to some embodiments.

Although specific embodiments are described below, these embodiments are not intended to limit the scope of the present disclosure, even where only a single embodiment is described with respect to a particular feature. Examples of features provided in the disclosure are intended to be illustrative rather than restrictive unless stated otherwise. The description herein is intended to cover such alternatives, modifications, and equivalents as would be apparent to a person skilled in the art having the benefit of this disclosure.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

### DETAILED DESCRIPTION

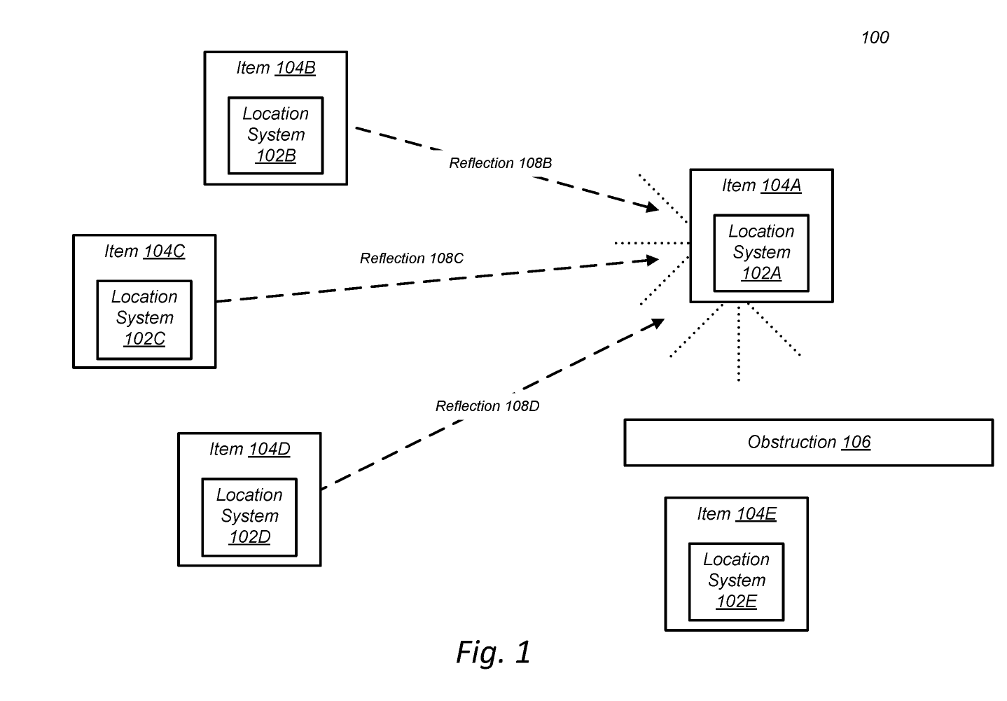

Referring now to FIG. 1, a block diagram illustrating an example environment 100 is depicted. In the illustrated embodiment, environment 100 includes a plurality of items 104 and a plurality of location systems 102 attached to the items 104. In various embodiments, one or more location systems 102 may be configured to determine a physical location of one or more items 104 in environment 100.

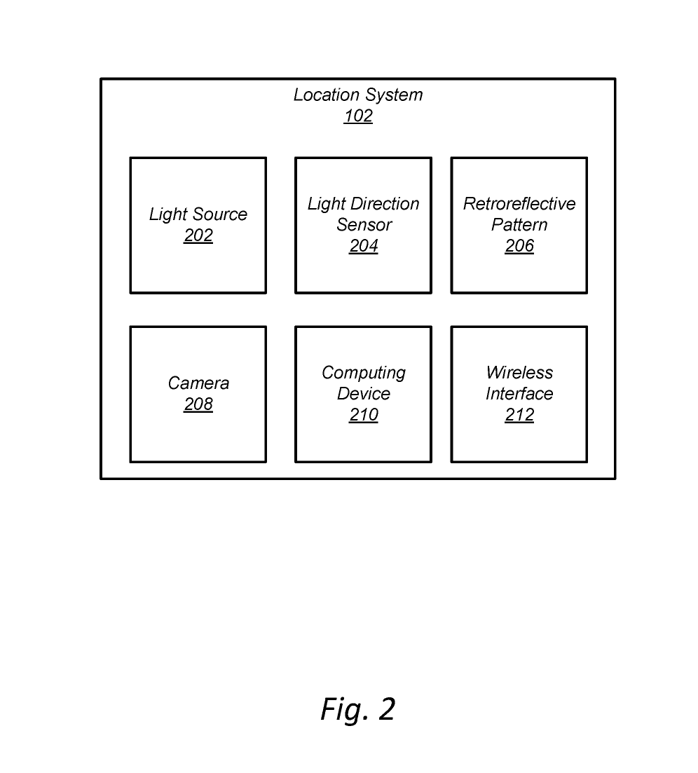

As discussed in more detail below with reference to FIG. 2, each of the items 104 in environment 100 may include retroreflective material arranged in a particular pattern on its surface. As will be appreciated by one of ordinary skill in the art, retroreflective material is a material that reflects some portion of incident light received at the material back in the direction of the source of the light. In various embodiments, location systems 102 may be configured to determine a location of one or more items 104 in environment 100 based on such reflections.

For example, in various embodiments, location system 102A may be configured to emit a pulse of light in environment 100. In some embodiments, light from that pulse may strike a subset of the items 104 in environment 100 and be reflected back in the direction of its source, location system 102A. In the depicted embodiment, for example, light emitted by location system 102A may strike items 104B, 104C, and 104D. In various embodiments, when the light strikes the retroreflective material included on the items 104B-104D, some portion of the light is reflected back to and received by location system 102A.

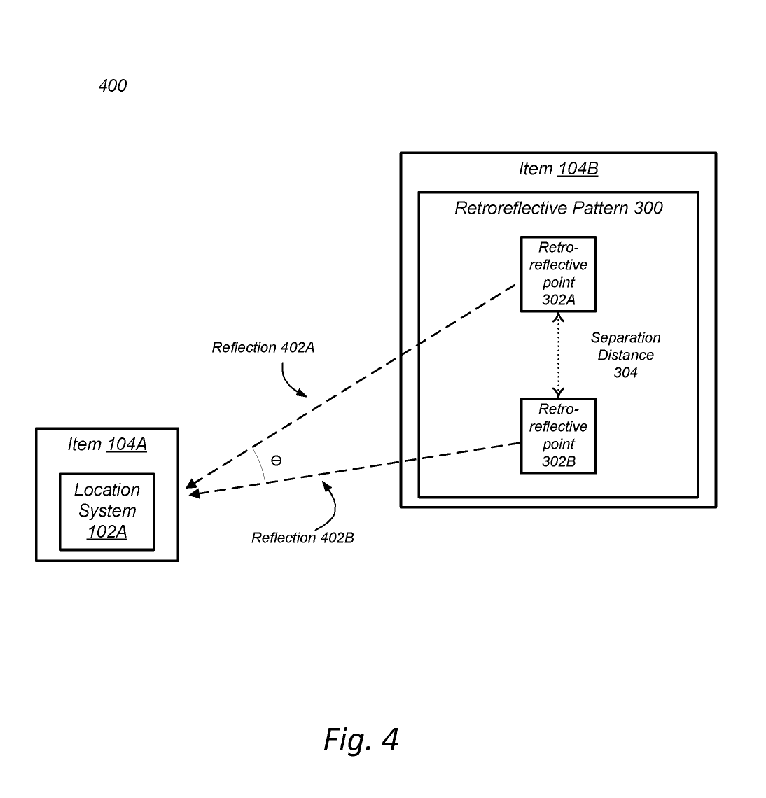

After receiving the reflections 108, location system 102A may determine a location of one or more of items 104B-104D. For example, location system 102A may determine a location of item 104B based on reflection 108B corresponding to item 104B. In some embodiments, location system may determine a direction of a location of item 104B relative to a reference location (e.g., the location of item 104A) based on an angle at which location system 102A receives reflection 108B. Further, in various embodiments, location system 102A may be configured to determine a distance between the reference location and item 104B based on reflection 108B, as described in more detail below with reference to FIG. 4. Additionally, subsequent to determining the direction of the location of item 104B, location system 102A may determine identification information associated with item 104B, in some embodiments. Accordingly, having determined the identification information associated with item 104B and its distance and direction from a given reference location, location system 102A, in various embodiments, may determine the location of item 104B in environment 100 relative to a reference location. In some embodiments, location system 102A may continue in a similar manner to determine a location of each of the items 104B-104D from which it received a reflection 108.

Note that, in the depicted embodiment, light emitted by location system 102A does not reach item 104E due to obstruction 106 located between items 104A and 104E. Accordingly, in such an embodiment, location system 102A would not receive a reflection corresponding to item 104E, and would therefore be unable to determine a location of item 104E. The location of item 104E may nonetheless be determined according to various embodiments of the disclosed systems. For example, in various embodiment, multiple location systems 102 may perform the process outlined herein to determine the location of items 104 within their line of sight. Further, once a location system 102 determines the location of one or more items 104, this location information may be communicated to or otherwise shared with other location systems 102 in the environment 100. For example, in one embodiment, location systems 102 may be configured to communicate with a server computer system (not shown), and may transmit location information corresponding to the items 104 to the server computer system. In some such embodiments, the server computer system may communicate this location information to the other location systems 102 in the environment 100. Thus, although location system 102A may be unable to determine the location of item 104E, location system 102D, for example, may be within a line of sight of item 104E and may be able to determine its location as described herein, according to some embodiments. Location system 102D may then communicate the location information to other location systems 102 or a server computer system. Thus, in some embodiments, location systems 102 may be capable of determining a location of a plurality of items 104 in environment 100.

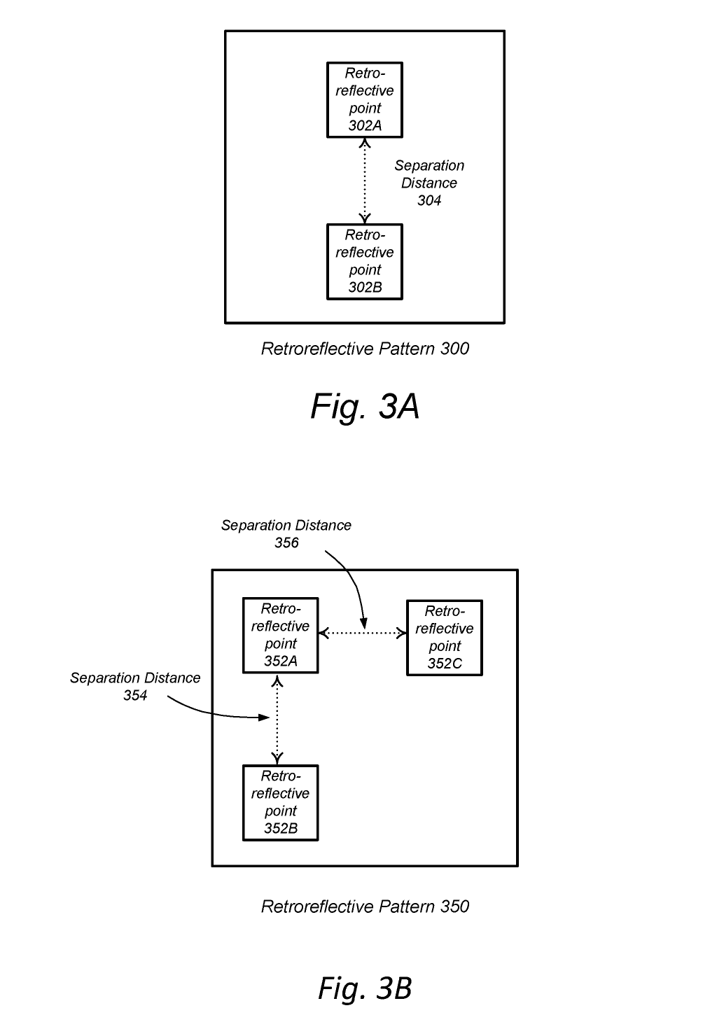

Further, note that a given location system 102 (e.g., location system 102A) may determine a location of an item 104 relative to a reference location, such as the location of location system 102A and/or item 104A to which it is attached. In various embodiments, once the physical location of any of the location systems 102 is established, the physical locations of the remaining location systems 102 may also be determined. For example, if the physical location of item 104A and its associated location system 102A are known to a user, this information may be used to determine a physical location for the remaining items 104 whose locations are not known to the user. In some embodiments, the user may establish a known location reference point by introducing an item 104 with a location system 102 at a known location within environment 100. Additionally, in some embodiments, environment 100 may include retroreflective patterns at known locations, which may be used by the location systems 102 to establish their physical location within environment 100, as discussed in more detail below with reference to FIGS. 3A-3B.

In various embodiments, the location information corresponding to items 104 in environment 100 may be utilized according to various techniques. For example, as noted, one or more location systems 102 may transmit location information to a server computer system, in some embodiments. In some such embodiments, a user may utilize a software application, for example on a mobile device, to view the location information. For example, the software application, in one embodiment, may provide a map or blueprint of environment 100, and may overlay the location of the items 104 at their corresponding location on the map.

Note that, in various embodiments, the nature of the items 104 and the environment 100 may vary without departing from the scope of this disclosure. For example, in one embodiment, environment 100 may include a warehouse in which various items 104, such as tools, computing devices, machinery, merchandise, etc., are distributed. In various embodiments, a location system 102 may include various items of hardware and software (described in more detail below with reference to FIG. 2) that may be incorporated into, retrofitted onto, or otherwise attached or associated with an item 104. Further, note that one or more of the items 104 may, but need not, be an Internet of Things (“IOT”) device. That is, in various embodiments, an item 104 may be an IOT device, such as a television, that is capable of sending and receiving information via the Internet. In some such embodiments, location system 102 may be incorporated into the IOT device in order to utilize various items of hardware, such as a wireless interface, included in the IOT device. In other embodiments, however, the location system 102 may be attached (e.g., via adhesive, brackets, or any other suitable mechanical attachment technique) to the IOT device and operate independently of the IOT device. Similarly, in embodiments in which an item 104, such as a speaker, is not an IOT device, location system 102 may be mechanically attached to the item 104 via any suitable techniques.

In various embodiments, the disclosed systems and methods for determining a physical location of one or more items in an environment may provide various advantages. For example, consider the situation described above, in which various items, such as tools, computing devices, machinery, merchandise, etc., are distributed throughout a warehouse. In such a situation, the user may be required to manually search the warehouse to locate a given item. The disclosed systems and methods, however, may allow the location systems to determine the location of the user's items in the environment. Further, in some embodiment, the user may view a blueprint or map of the environment in a software application, with a marker provided at the location of each of the user's items. This, in turn, may result in reduced time spent retrieving the items, reduce the number of items lost by the user, and simplify the user's inventory process. Thus, in various embodiments, the disclosed systems and methods may provide various advantages, particularly as it relates to determining the physical location of items within an environment.

Turning now to FIG. 2, a block diagram of an example location system 102 is shown, according to some embodiments. In the embodiment depicted in FIG. 2, location system 102 includes light source 202, light direction sensor 204, retroreflective pattern 206, camera 208, computing device 210, and wireless interface 212. In various embodiments, location system 102 may be configured to determine a physical location of one or more items 104 in an environment 100.

In various embodiments, light source 202 may include one or more fluorescent lamps, LEDs, or any other light source suitable to emit a flash of light to induce reflections from other location systems 102 in a given environment. In some embodiments, location systems 102 may be configured to communicate via visible light communication (“VLC”). In such embodiments, light source 202 may be any light source suitable for transmitting information via VLC. Further note that, in some embodiments in which location systems 102 communicate via VLC, location system 102 may further include may further include one or more optical sensors (e.g., photodiodes) suitable for use in VLC. Location system 102 of FIG. 2 further includes light direction sensor 204. In various embodiments, light direction sensor 204 may be configured to receive one or more reflections from other location systems 102 and determine a direction from which those reflections originated.

Location system 102 further includes retroreflective pattern 206. As discussed in more detail below with reference to FIGS. 3A and 3B, retroreflective pattern 206 includes retroreflective material arranged in a particular pattern. For example, in some embodiments, retroreflective pattern 206 includes retroreflective material arranged in a pattern on a surface of an item 104. In some embodiments, retroreflective pattern 206 may include a plurality of retroreflective points arranged in a pattern on the surface of an item 104. Further, in some embodiments, a given item 104 may include multiple instances of retroreflective pattern 206 located on various sides of the item 104. Such a configuration may facilitate locating an item 104 even when one of the retroreflective patterns 206 on that item 104 are facing away from the location system 102A attempting to determine its location. In various embodiments, retroreflective pattern 206 may be affixed to an item 104 using retroreflective paint, tape, adhesive, or any other suitable techniques for attaching retroreflective material in a particular pattern on the item 104.

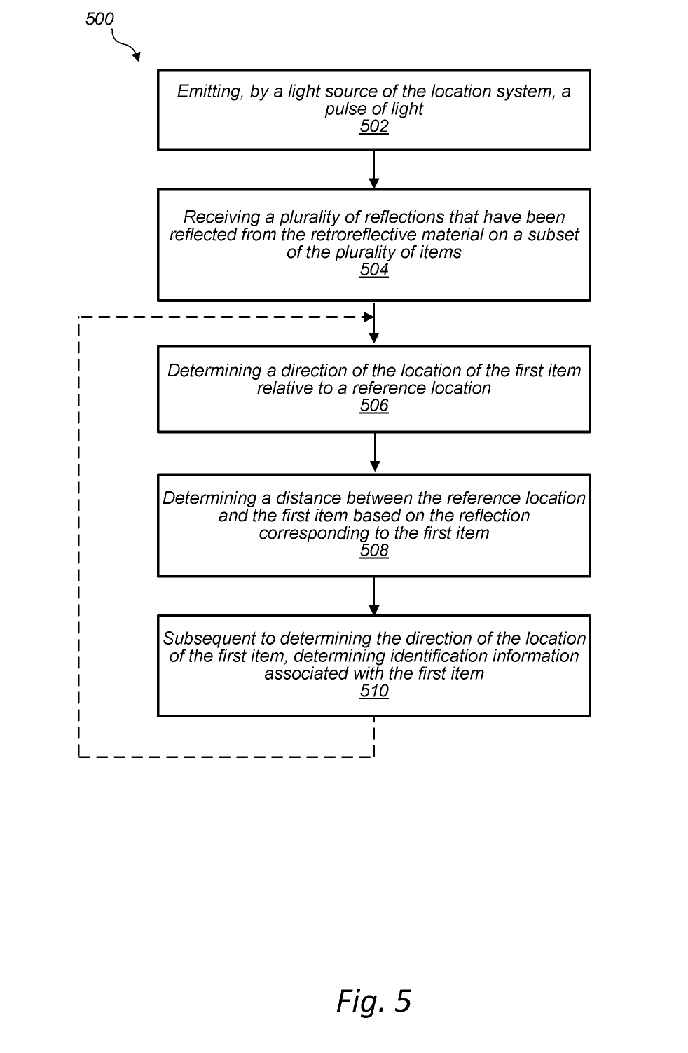

As depicted in FIG. 2, location system 102 further includes camera 208. In various embodiments, camera 208 may include any suitable device for capturing images. For example, in some embodiments, camera 208 may use complimentary metal-oxide-semiconductor (CMOS) sensors to capture rows of pixels to construct an image. In embodiments in which location systems 102 communicate via VLC, camera 208 may be configured to receive and detect information sent by a location system 102 via VLC. Further, location system 102 of FIG. 2 includes computing device 210. In various embodiments, computing device 210 may be configured to determine a location of an item 104 in an environment. For example, in some embodiments, computing device 210 may be configured to implement method 500 of FIG. 5 (described in more detail below) to determine a location of an item 104.

As shown in FIG. 2, location system 102 may further include wireless interface 212, which, in various embodiments, may be configured to use various communication protocols, such as near-field communications (NFC), WiFi Direct, Bluetooth, etc. In various embodiments, wireless interface 212 may be configured to send information indicative of the location of one or more items 104 to a computer system, such as a remote server computer system, for example.

Referring now to FIG. 3A, a block diagram of a retroreflective pattern 300 is shown. Retroreflective pattern 300 may be included, for example, on one or more items 104 in environment 100 of FIG. 1.

In various embodiments, retroreflective pattern 300 may include retroreflective material arranged in a particular pattern on an item 104. In the embodiment depicted in FIG. 3A, retroreflective pattern 300 includes retroreflective points 302A and 302B separated by a separation distance 304. In various embodiments, retroreflective points 302A and 302B may include retroreflective material that is configured to reflect light back to its source. For example, as discussed above, location system 102A may be configured to emit a pulse of light that may strike one or more items 104 in environment 100, such as an item 104B that includes retroreflective pattern 300. In response to striking retroreflective pattern 300, retroreflective points 302A and 302B may reflect a portion of the light back to its source, location system 102A. As discussed in more detail below with reference to FIG. 4, location system 102A may use the reflections corresponding to item 104B to determine a distance between a reference location and item 104B.

Turning now to FIG. 3B, a block diagram of a retroreflective pattern 350 is shown. In the depicted embodiment, retroreflective pattern 350 includes three retroreflective points 352A-352C, with retroreflective points 352A and 352B separated by a separation distance 354, and retroreflective points 352A and 352C separated by a separation distance 356.

In some embodiments, it may be advantageous to include more than two retroreflective points 352 in a retroreflective pattern, for example to facilitate more accurate distance determinations by a location system 102. For example, in an embodiment in which location system 102A emits a pulse of light that strikes an item 104D that includes retroreflective pattern 350, retroreflective points 352A-352C may each reflect a portion of the light back to its source, location system 102A. In such an embodiment, location system 102A may determine the distance between the reference location and item 104D based on three reference points (corresponding to retroreflective points 352A-352C) and two separation distances 354-356. By having more available information, the addition of a third retroreflective point 352 may permit location system 102A to make a more accurate distance determination, according to some embodiments. Further, as discussed in more detail below with reference to FIG. 4, the addition of retroreflective point 352C may permit location system 102A to determine an orientation of one or more items 104, in addition to their locations.

Note that, in various embodiments, the separation distances 304, 354, and 356 depicted in FIGS. 3A-3B may vary. For example, in some embodiments, an item 104 on which it would be desirable to include a retroreflective pattern may be relatively small, such as a router, and therefore the item 104 may unable to accommodate placement of a large retroreflective pattern on its surface. In such situations, a retroreflective pattern with proportionately short separation distances (e.g., two inches) may be placed on the item. Alternatively, in some embodiments, an item 104 on which it would be desirable to place a retroreflective pattern may be relatively large, such as an audio speaker, and therefore the item 104 may be able to accommodate placement of a larger retroreflective pattern on its surface. In such embodiments, a retroreflective pattern with proportionately larger separation distances (e.g., 12 inches) may be placed on the item. In some embodiments, the use of larger separation distances may allow for a larger angle between corresponding reflections received by a location system 102, which in turn may result in more accurate distance determinations.

Further, note that, in some embodiments, the retroreflective patterns may include retroreflective material arranged in a barcode, a QR code, or any other suitable machine-readable optical code format. In such embodiments, the retroreflective pattern may include information encoded into the machine-readable code, such as identification information associated with the item 104 on which the retroreflective pattern is attached, separation distance(s) between two or more retroreflective points on the item 104, etc. Further, in such embodiments, one or more of the reflections received back at location system 102A may include a reflected version of a machine-readable code (e.g., QR code), which location system 102A may use in determining identification information associated with the item from which the reflected machine-readable code originated.

Additionally, in some embodiments, a retroreflective pattern, such as retroreflective pattern 300 or 350, may be placed on an item without a location system 102. For example, in some embodiments, it may be desirable to place a retroreflective pattern on a fixed object of known location, such as a wall, to allow other location systems 102 to determine their own location relative to a known location within a given environment 100. For example, a distinct retroreflective pattern (e.g., a retroreflective pattern with a particular number of retroreflective points) may be placed in the environment 100 on a fixture of known location, according to some embodiments. In such embodiments, location systems 102 may recognize the distinct retroreflective pattern as a known geographic location point, and may determine their own location within environment 100 based on this known geographic location. Further, in some embodiments, placing a retroreflective pattern on an item 104 without a complete location system 102 may be desirable for situations in which it is impractical to attach the other hardware components included in a location system on the item, for example due to the item's size.

Referring now to FIG. 4, a block diagram is shown of a location system 102A determining a distance between an item 104B and a reference point, according to some embodiments. For example, in some embodiments, location system 102A may determine a distance between item 104A and item 104B based on reflections 402 corresponding to item 104B.

FIG. 4 depicts item 104A, including location system 102A, and item 104B, which includes retroreflective pattern 300 from FIG. 3A. In some embodiments, retroreflective pattern 300 may be included as part of a location system 102B (not shown) that is connected to item 104B.

As discussed above, location system 102A may be configured to determine the location of one or more items 104 within an environment 400. In various embodiments, location system 102A may emit a pulse of light, for example using light source 202. When this pulse of light is received at item 104B, it may strike one or more retroreflective points 302 in retroreflective pattern 300. For example, in the depicted embodiment, the pulse of light emitted by location system 102A strikes retroreflective points 302A and 302B. Once the pulse of light reaches item 104B, retroreflective points 302A and 302B are configured to reflect some portion of that light back to its source, location system 102A. For example, as shown in FIG. 4, location system 102A receives reflections 402 corresponding to item 104B. More particularly, location system 102A receives reflections 402A and 402B corresponding to retroreflective points 302A and 302B, respectively.

In various embodiments, after receiving the reflections 402, location system 102A may be configured to detect one or more reference points in the reflection 402 corresponding to item 104B. For example, in the depicted embodiment, location system 102A may be configured to detect first and second reference points in the reflections 402, where the first and second reference points respectively correspond to retroreflective points 302A-302B in retroreflective pattern 300. Further, in various embodiments, location system 102A may be configured to determine an angle between the first reference point and the second reference point. For example, as shown in FIG. 4, location system 102A may be configured to determine an angle θ between the first reference point and the second reference point.

In various embodiments, location system 102A may be configured to determine the distance between a reference location, such as the location of item 104A, and item 104B based on the angle θ between the first and second reference points and the separation distance 304 between retroreflective points 302A-302B. For example, in embodiments in which the distance between items 104A and 104B (e.g., 50 feet) is much larger than the separation distance 304 (e.g., 6 inches), the distance between items 104A and 104B may be approximated as follows:

$$D \approx \frac{S D}{tan θ}$$

Where D is the distance between items 104A and 104B, SD is the separation distance 304 between retroreflective points 302A and 302B, and θ is the angle between the first and second reference points. Note, however, that this described technique for determining the distance between items 104 is provided merely as an example and is not intended to limit the scope of this disclosure. One of ordinary skill in the art with the benefit of this disclosure will recognize that various techniques may be implemented to determine such a distance without departing from the scope of the present disclosure.

Thus, in various embodiments, location system 102A may determine a distance between a reference location (e.g., the location of item 104A) and an item 104 based on the reflections received back at the location system 102A. In various embodiments, this may eliminate the need for additional hardware, such as a laser range finder, to determine the distance between items 104 in environment 100.

Location system 102A may determine separation distance 304 according to various techniques. For example, in some embodiments, location system 102A may store information corresponding to retroreflective patterns 300, such as information indicative of the separation distance 304 between retroreflective points 302, which may permit location system 102A to determine the distance between an item 104 and a reference location based on this stored information. In one embodiment, for example, each of the retroreflective patterns 300 implemented within a given environment 400 may be the same, such that each has the same separation distance 304 between retroreflective points 302A and 302B. In such embodiments, location system 102A may store information corresponding to retroreflective pattern 300, such as the value of the separation distance 304, and use this information to determine the distance between items 104.

In other embodiments, however, multiple retroreflective patterns may be implemented in a given environment 400. For example, in one embodiment, both retroreflective patterns 300 and 350 of FIGS. 3A-3B may be used within a given environment 400. In such an embodiment, location system 102A may store information corresponding to both retroreflective patterns 300 and 350, such as the values of the separation distances 304, 354, and 356. Further, in such embodiments, location system may distinguish between these two retroreflective patterns 300 and 350 based on a number of reference points detected in a reflection from a particular area. For example, if location system 102A detects only two reference points in a reflection from a particular direction, location system 102A may determine that the reflection originated from an item 104 that included retroreflective pattern 300, and may use the stored information corresponding to retroreflective pattern 300 to determine the distance between the item 104 and a reference location. If, however, location system 102A detects three reference point in a reflection from a particular area, location system 102A may determine that the reflection originated from an item 104 that included retroreflective pattern 350, and may use the stored information corresponding to retroreflective pattern 350 to determine the distance between the item 104 and a reference location.

Further, in some embodiments, location systems 102 may be configured to communicate information corresponding to the separation distances 304. For example, after determining a direction to the location of item 104B, location system 102A of FIG. 4 may be configured to request information from a location system 102B (not shown) associated with item 104B, such as identification information and information associated with retroreflective pattern 300, such as separation distance 304. After receiving the information indicative of the separation distance 304, location system 102A may determine the distance between item 104B and a reference location. This embodiment may allow for the retroreflective patterns to vary, for example due to the size constraints of the item 104 on which the retroreflective pattern is included.

As noted above, in some embodiments, location system 102A may be configured to determine orientation information associated with an item 104 based on the reflections 402 received back by location system 102A. For example, in embodiments in which a retroreflective pattern includes three or more retroreflective points, location system 102A may be configured to determine an orientation of an item 104 based on the reference points included in the reflection from that retroreflective pattern. For example, consider an item 104C that includes a retroreflective pattern (not shown) with four retroreflective points arranged in a square pattern. In such an embodiment, the separation distances between the four retroreflective points may be the same. If, however, location system 102A determines that, based on the measured angles between the reference points and the distance between the item 104C and the reference location, the perceived separation distances are not the same, location system 102A may determine that item 104C is turned relative to the location system 102A.

Turning now to FIG. 5, a flow diagram of an example method 500 for determining a location of a first item of a plurality of items is shown, according to some embodiments. In various embodiments, method 500 may be implemented, for example, by location system 102A of FIG. 1. FIG. 5 includes blocks 502-510. While these blocks are shown in a particular order for ease of understanding, other orders may be used. Block 502 includes emitting, by a light source of a location system, a pulse of light. For example, location system 102A of FIG. 1 may emit a pulse of light via light source 202 in environment 100.

Method 500 then proceeds to block 504, which includes receiving a plurality of reflections that have been reflected from the retroreflective material on a subset of the plurality of items. For example, location system 102A may receive reflections that have been reflected off of retroreflective material on items 104B, 104C, and 104D. Location system 102A may not, however, receive a reflection from one or more other items 104 in environment 100. For example, in the embodiment depicted in FIG. 1, location system 102A may not receive a reflection that has been reflected off item 104E due to the obstruction 106 located between items 104A and 104E.

Method 500 then proceeds to block 506, which includes determining a direction of the location of the first item relative to the reference location. In some embodiments, the reference location is a location of the location system 102 that is determining the location of one or more other items 104 in environment 100. For example, location system 102A may determine a direction of the location of item 104B relative to its own location using light direction sensor 204.

Method 500 then proceeds to block 508, which includes determining a distance between the reference location and the first item based on the reflection corresponding to the first item. For example, as explained in more detail above with reference to FIG. 4, location system 102A may determine a distance between item 104A and 104B by detecting first and second reference points in the reflection corresponding to item 104B, determining an angle between the first reference point and the second reference point, and determining the distance between items 104A and 104B based on the angle and the separation distance 304 between the first and second retroreflective points 302A-302B.

Method 500 then proceeds to block 510, which includes, subsequent to determining the direction of the location of the first item, determining identification information associated with the first item. Location system 102A may use various techniques to determine identification information associated with items 104B-D. For example, in some embodiments, location system 102A may use light source 202 and camera 208 communicate with one or more location system 102B-102D via visible light communication. In such embodiments, block 510 may include location system 102A controlling camera 208 to point in the direction of item 104B, sending, by location system 102A to location system 102B, a request for identification information associated with item 104B, and receiving, by location system 102A, identification information from location system 102B.

As shown in FIG. 5, in some embodiments, method 500 may include repeating blocks 506-510 one or more times. For example, in some embodiments, method 500 includes determining a location of each item in the subset of items from which location system 102A received a reflection. In such embodiments, method 500 may include repeating blocks 506-510 for each of the received reflections. For example, after determining the location of item 104B, location system 102A may proceed to determining the location of item 104C by determining a direction of the location of item 104C relative to the reference location, determining a distance between the reference location and item 104C based on the reflection corresponding to item 104C, and, subsequent to determining the direction of the location of item 104C, determining identification information associated with item 104C. In various embodiments, method 500 may continue in such a manner until location system 102A has determined the location for each item 104 from which it received a reflection.

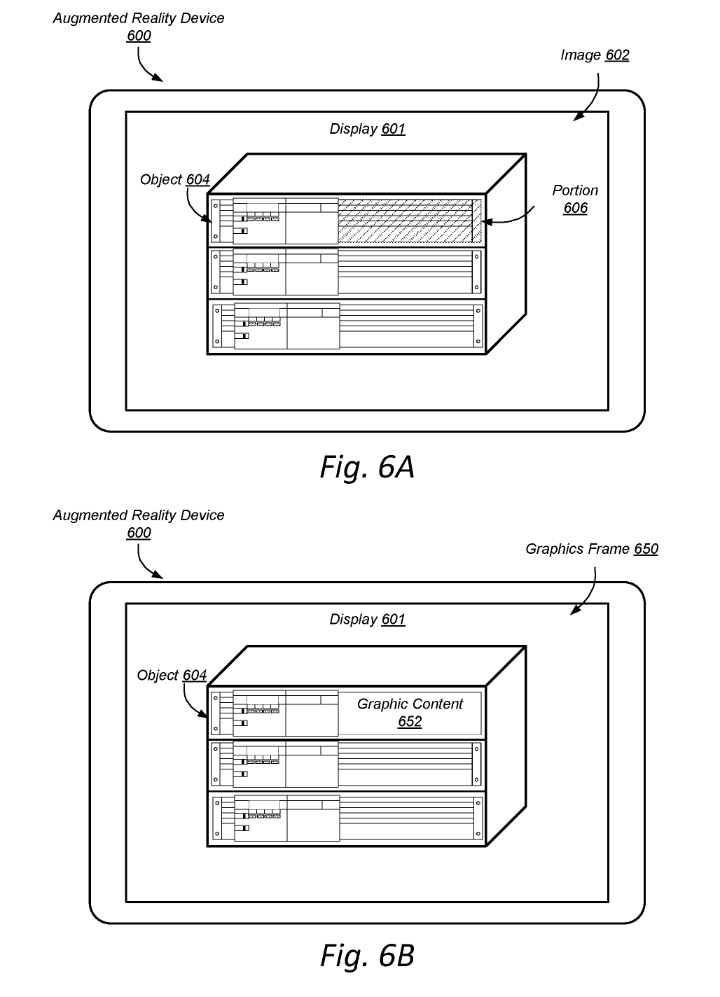

With reference to FIGS. 6-8 below, systems and methods for overlaying computer-generated graphic content in an augmented reality (AR) environment are described. As discussed in more detail below, the disclosed systems and methods may reduce “visual clutter” when viewing objects using an AR device. This reduction of visual clutter may, in turn, allow a user to more clearly view the computer-generated graphic content, which may otherwise be obstructed by physical features on the surface of the object.

Referring now to FIGS. 6A-6B, an example AR device 600 is depicted, according to some embodiments. As shown in FIG. 6A, AR device 600 includes a display 601, which may be used to present various images and videos. In the depicted embodiment, an image 602 is depicted in display 601. In various embodiments, image 602 may correspond to an image captured of object 604 using a camera of AR device 600. Note that, in the embodiment of FIG. 6A, object 604 includes a server computer system located in a server rack. This depicted embodiment, however, is provided merely as an example and is not intended to limit the scope of the present disclosure. In other embodiments, for example, the object 604 may include any suitable item (such as one or more of the items 104 of FIG. 1) or device.

As shown in FIG. 6A, object 604 includes portion 606, which may include a portion of object 604 that is painted in a particular color. For example, in some embodiments, the particular color may include in a “rare” color, such as a distinctive shade of green, blue, purple, etc., that is distinct in hue from many commonly-occurring colors. In various embodiments, painting portion 606 in the particular portion may facilitate incorporating computer-generated graphic content into a graphic frame that may be depicted by display 601.

Further, portion 606 may include an identifier 608 (not shown). In various embodiments, identifier 608 may include a machine-readable optical code, such as a bar code or QR code, with information associated with object 604 encoded into the identifier. In some embodiments, identifier 608 may uniquely identify object 604 such that data associated with object 604 may be retrieved. For example, in the depicted embodiment, AR device 600 may detect the identifier 608 from the image 602. Further, AR device 600 may send a request to a remote server computer system (not necessarily object 604) for data associated with object 604 based on the identifier 608. In various embodiments, AR device 600 may be configured to overlay computer-generated graphic content in portion 606 that is painted in the particular color.

Turning now to FIG. 6B, AR device 600 is shown with graphics frame 650 depicted in display 601. In various embodiments, graphics frame 650 may include an image that has been modified to include one or more computer-generated graphic components. For example, graphics frame 650, like image 602, includes a depiction of object 604. In graphics frame 650, however, computer-generated graphic content 652 has been added. More specifically, graphic content 652 has been overlaid on top of object 604 within the boundary of the portion 606 that is painted in the particular color.

In various embodiments, AR device 600 may generate graphics frame 650 based on image 602. For example, in some embodiments, AR device 600 may determine a location to overlay graphic content 652 by detecting a boundary of the portion 606 painted in the particular color. Further, in some embodiments, AR device 600 may remove (e.g., filter) some percentage of the portion 606 based on the particular color and, in that space within graphics frame 650, overlay graphic content 652. In various embodiments, the graphic content 652 may be based on the data associated with object 604. Note that the nature of the graphic content 652 may vary based on the object 604 on which it is overlaid. In the depicted example, in which object 604 is a server computer system, graphic content 652 may include identification or status information associated with the server computer system, such as a MAC address, reported performance issues, etc.

In various embodiments, the disclosed systems and methods for providing computer-generated content in an augmented reality environment may provide various improvements to the functioning of AR device and to the AR user experience. For example, when viewing an object 604 in using an AR device, it may be desirable to incorporate computer-generated graphic content onto the object, to view useful information relating to the object. Most physical objects, however, were not specifically designed for viewing in an AR environment. For example, consider a situation in which the surface of object includes numerous components (e.g., buttons, labels, handles, etc.). In such a situation, when the AR device incorporates the computer-generated graphic content with the image of the object, the resulting image may be visually cluttered, making it difficult for a user to discern the added graphic content from the numerous features on the surface of object. This result renders addition of the graphic content less useful and detracts from the user experience. The disclosed systems and methods, however, may allow for more effective incorporation of computer-generated graphic content onto an object when viewed using an AR device. For example, by painting a portion, such as the components or casing, of the object with the particular color, the AR device may be able to detect a boundary of the portion, filter some amount of that portion from the image, and overlay graphic content in that space within a graphics frame. In various embodiment, this may result in a graphics frame with useful graphic content and less visual clutter, rendering the AR device more useful to the user. Thus, in various embodiments, the disclosed systems and methods may provide various advantages, particularly as it relates to incorporating computer-generated graphic content into an image in a AR context.

Note that, although only one portion 606 is shown in FIG. 6A, this embodiment is provided merely as an example and is not intended to limit the scope of the present disclosure. In other embodiments, for example, a given object may be painted with multiple portions 606, one or more of which may be painted in a different distinct color. Further, in some embodiments, object 604 may include multiple identifiers, which may be used to retrieve different data sets associated with the object 604. For example, in an embodiment in which object 604 is a server computer system, multiple entities associated with the object 604 (e.g., manufacturer, party utilizing the server computer system, datacenter operator, etc.) may each include one or more identifiers on object 604. In such embodiments, a user may capture an image 602 of object 604 using AR device 600. Further, AR device 600 may detect the multiple identifiers included on the object 604. In various embodiments, the user may utilize AR device 600 to select one of the plurality of entities and view graphic content 652 provided by or associated with that entity overlaid on object 604. Additionally, in some embodiments, the multiple identifiers may permit graphic content 652 in different languages to be incorporated into the graphic frame 650, as desired by the user.

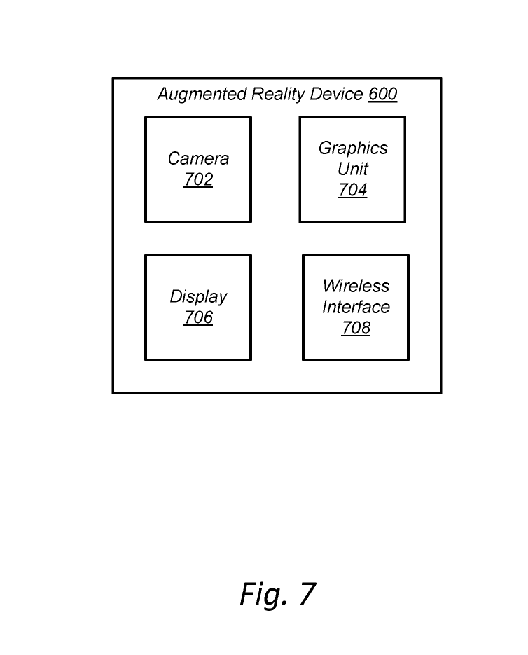

Turning now to FIG. 7, a block diagram of an example AR device 600 is shown, according to some embodiments. In the embodiment depicted in FIG. 7, AR device 600 includes camera 702, graphics unit 704, display unit 706, and wireless interface 708. Note that, although not specifically depicted in FIG. 7, AR device 600 may include any other suitable components, such as display 601 shown in FIG. 6.

As depicted in FIG. 7, AR device 600 includes camera 702. In various embodiments, camera 702 may include any suitable device for use in an AR device. For example, in some embodiments, camera 702 may use CMOS sensors to capture rows of pixels to construct an image, such as an image 602 of object 604 in FIG. 6A.

AR device 600 further includes graphics unit 704. Graphics unit 704 may include one or more processors and/or one or more graphics processing units (GPU's). Graphics unit 704 may receive graphics-oriented instructions and execute GPU instructions or perform other operations based on the received graphics-oriented instructions. Graphics unit 704 may generally be configured build images in a frame buffer for output to a display. AR device 600 further includes display unit 706. Display unit 706 may be configured to read data from a frame buffer and provide a stream of pixel values for display. Further, display unit 706 may include one or more interfaces for coupling to display 601.

AR device 600 further includes wireless interface 708, which, in various embodiments, may be configured to use various communication protocols, such as near-field communications (NFC), WiFi Direct, Bluetooth, etc. In various embodiments, wireless interface 708 may be configured to send requests for data associated with one or more objects to a server computer system and receive, from the server computer system, the data associated with the object, for example.

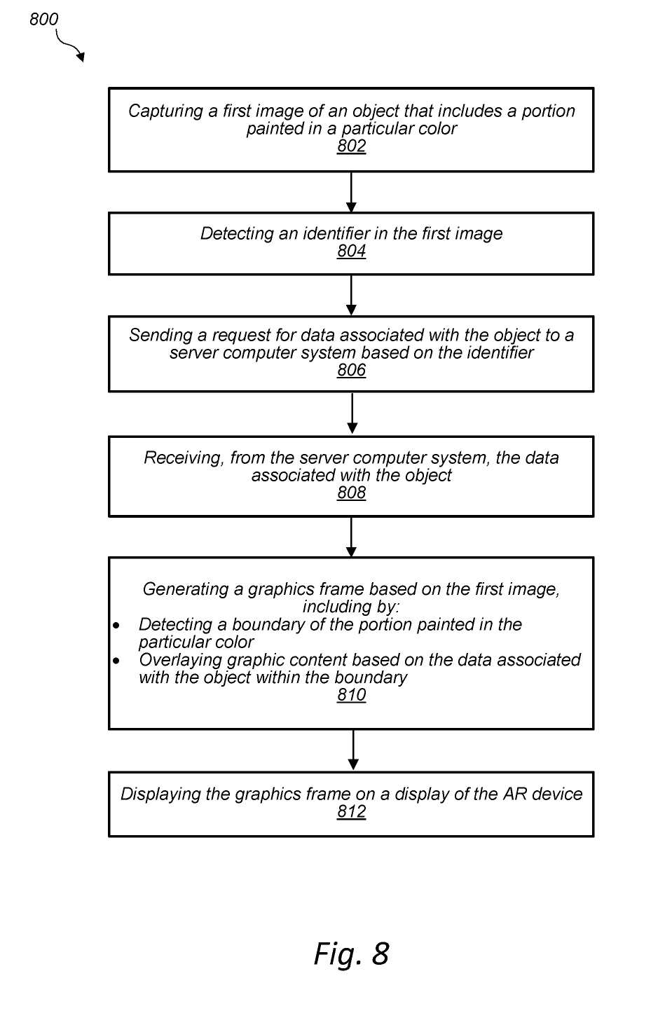

Referring now to FIG. 8, a flow diagram of an example method 800 for overlaying graphic content in an augmented reality environment is shown, according to some embodiments. In various embodiments, method 800 may be implemented, for example, by AR device 600 of FIG. 6. FIG. 8 includes blocks 802-812. While these blocks are shown in a particular order for ease of understanding, other orders may be used. Block 802 includes capturing an image of an object that includes a portion painted in a particular color. For example, as discussed above, the particular color may include a color that is distinct in hue from commonly-occurring colors.

Method 800 then proceeds to block 804, which includes detecting an identifier in the first image. For example, in one embodiment, AR device 600 may detect an identifier in the form of a machine-readable optical code, such as a QR code, in the first image. Further, in some embodiments, the identifier may be included in the portion painted in the particular color. In other embodiments, however, the identifier may be included on some portion of the object other than the portion painted in the particular color.

Method 800 then proceeds to block 806, which includes sending a request for data associated with the object to a server computer system based on the identifier. For example, in some embodiments, AR device 600 may send a request to a server computer system storing information associated with the object. In such embodiments, the server computer system may be configured to service requests from AR device 600 by retrieving data associated with the object based on the identifier and sending that data to AR device 600. Method 800 then proceeds to block 808, which includes receiving, from the server computer system the data associated with the object.

Method 800 then proceeds to block 810, which includes generating a graphics frame based on the first image. In some embodiments, block 810 may include generating the graphics frame by detecting a boundary of the portion painted in the particular color, and overlaying graphic content based on the data associated with the boundary. For example, as depicted in FIG. 6A, AR device may detect a boundary of the portion 606 painted in the particular color. Further, as depicted in FIG. 6B, AR device may overlay graphic content 652 within that boundary, where the graphic content may be based on the data associated with the object 604. Method 800 then proceeds to block 812, which includes displaying the graphics frame on a display 601 of the AR device 600. For example, AR device 600 may display graphics frame 650 in its display 601.

### Example Computer System

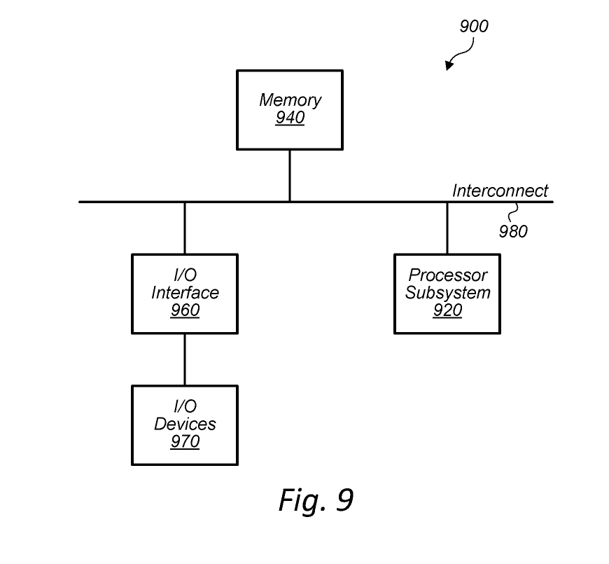

Turning now to FIG. 9, a block diagram of an example computer system 900, which may implement one or more computer systems, such as computing device 210 of FIG. 2, is depicted. Computer system 900 includes a processor subsystem 920 that is coupled to a system memory 940 and I/O interfaces(s) 960 via an interconnect 980 (e.g., a system bus). I/O interface(s) 960 is coupled to one or more I/O devices 970. Computer system 900 may be any of various types of devices, including, but not limited to, a server system, personal computer system, desktop computer, laptop or notebook computer, tablet computer, handheld computer, workstation, network computer, a consumer device such as a mobile phone, music player, or personal data assistant (PDA). Although a single computer system 900 is shown in FIG. 9 for convenience, computer system 900 may also be implemented as two or more computer systems operating together.

Processor subsystem 920 may include one or more processors or processing units. In various embodiments of computer system 900, multiple instances of processor subsystem 920 may be coupled to interconnect 980. In various embodiments, processor subsystem 920 (or each processor unit within 920) may contain a cache or other form of on-board memory.

System memory 940 is usable to store program instructions executable by processor subsystem 920 to cause system 900 perform various operations described herein. System memory 940 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 900 is not limited to primary storage such as system memory 940. Rather, computer system 900 may also include other forms of storage such as cache memory in processor subsystem 920 and secondary storage on I/O Devices 970 (e.g., a hard drive, storage array, etc.). In some embodiments, these other forms of storage may also store program instructions executable by processor subsystem 920.

I/O interfaces 960 may be any of various types of interfaces configured to couple to and communicate with other devices, according to various embodiments. In one embodiment, I/O interface 960 is a bridge chip (e.g., Southbridge) from a front-side to one or more back-side buses. I/O interfaces 960 may be coupled to one or more I/O devices 970 via one or more corresponding buses or other interfaces. Examples of I/O devices 970 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 970 includes a network interface device (e.g., configured to communicate over WiFi, Bluetooth, Ethernet, etc.), and computer system 900 is coupled to a network via the network interface device.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, if a location system determines locations of four items in an environment, the terms “first item” and “second item” can be used to refer to any two of the four items.

When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
determining, by a location system, a location of a first item of a plurality of items, each item having retroreflective material arranged in a particular pattern, wherein the determining includes:
emitting, by a light source of the location system, a pulse of light;
receiving, at the location system, a plurality of reflections that have been reflected from the retroreflective material on a subset of the plurality of items;
determining, by the location system, a direction of the location of the first item relative to a reference location, wherein the direction is determined based on an angle of a reflection corresponding to the first item;
determining, by the location system, a distance between the reference location and the first item based on the reflection corresponding to the first item; and
subsequent to determining the direction of the location of the first item, determining, by the location system, identification information associated with the first item.

2. The method of claim 1, wherein the determining the distance between the reference location and the first item comprises:
detecting, by the location system, first and second reference points in the reflection corresponding to the first item, wherein the first and second reference points respectively correspond to first and second retroreflective points included in the particular pattern on the first item;
determining, by the location system, an angle between the first reference point and the second reference point; and
determining, by the location system, the distance between the reference location and the first item based on the angle and a distance between the first and second retroreflective points.

3. The method of claim 2, further comprising:
receiving, by the location system from the first item, information indicative of the distance between the first and second retroreflective points, wherein the determining the distance between the reference location and the first item is based on the received information.

4. The method of claim 1, wherein determining the identification information associated with the first item comprises:
controlling, by the location system, a camera of the location system to point in the direction of the location of the first item;
sending, by the location system to a location system associated with the first item, a request for the identification information associated with the first item; and
receiving, by the location system, the identification information from the location system associated with the first item.

5. The method of claim 4, wherein the request is sent via visible light communication.

6. The method of claim 1, wherein, for the first item, the particular pattern includes a QR code operable to identify the first item, wherein the reflection corresponding to the first item includes a reflected version of the QR code, and wherein the determining the identification information associated with the first item is based on the reflected version of the QR code.

7. The method of claim 2, further comprising:
determining, by the location system, an orientation of the first item based on an angle between the first and second reference points relative to a reference angle.

8. The method of claim 1, wherein the reference location is a location of the location system.

9. A non-transitory, computer-readable medium having instructions stored thereon that are executable by a location system to perform operations comprising:
determining, by the location system, a location of a first item of a plurality of items, each item having retroreflective material arranged in a particular pattern, wherein the determining includes:
controlling a light source of the location system to emit a pulse of light;
receiving information indicative of a plurality of reflections that have been reflected from the retroreflective material on a subset of the plurality of items and received at the location system;
determining a direction of the location of the first item relative to a reference location, wherein the direction is determined based on an angle of the reflection corresponding to the first item;
determining a distance between the reference location and the first item based on the reflection corresponding to the first item; and
subsequent to determining the direction of the location of the first item, determining identification information associated with the first item.

10. The non-transitory, computer-readable medium of claim 9, wherein the determining the distance between the reference location and the first item comprises:
detecting first and second reference points in the reflection corresponding to the first item, wherein the first and second reference points respectively correspond to first and second retroreflective points included in the particular pattern on the first item;
determining an angle between the first reference point and the second reference point; and
determining the distance between the reference location and the first item based on the angle and a distance between the first and second retroreflective points.

11. The non-transitory, computer-readable storage medium of claim 10, wherein the operations further comprise:
storing, by the location system, information indicative of the distance between the first and second retroreflective points included in the particular pattern, wherein the determining the distance between the reference location and the first item is based on the stored information.

12. The non-transitory, computer-readable storage medium of claim 10, wherein the operations further comprise:
determining an orientation of the first item based on an angle between the first and second reference points relative to a reference angle.

13. The non-transitory, computer-readable storage medium of claim 10, wherein the operations further comprise:
determining a location of each item in the subset of the plurality of items.

14. The non-transitory, computer-readable storage medium of claim 13, wherein the determining the location of each item in the subset comprises, for a given item in the subset:
determining a direction of the location of the given item relative to the reference location, wherein the direction is determined based on an angle of the reflection corresponding to the given item;
determining a distance between the reference location and the given item based on the reflection corresponding to the given item; and
subsequent to determining the direction of the location of the given item, determining identification information associated with the given item.

15. A location system, comprising:
a light source configured to emit a pulse of light;
a light-direction sensor configured to receive a plurality of reflections that have been reflected from retroreflective material on a subset of a plurality of items; and
a computer system configured to determine a location of a first item of a plurality of items, each item having retroreflective material arranged in a particular pattern, wherein the determining includes:
determine a direction of the location of the first item relative to a reference location, wherein the direction is determined based on an angle of the reflection corresponding to the first item received by the light-direction sensor;
determine a distance between the reference location and the first item based on the reflection corresponding to the first item; and
determine identification information associated with the first item.

16. The location system of claim 15, wherein determining the distance between the reference location and the first item comprises:
detecting first and second reference points in the reflection corresponding to the first item, wherein the first and second reference points respectively correspond to first and second retroreflective points included in the particular pattern on the first item;
determining an angle between the first reference point and the second reference point; and
determining the distance between the reference location and the first item based on the angle and a distance between the first and second retroreflective points.

17. The location system of claim 15, wherein the location system is associated with a given item, wherein the location system further comprises:
retroreflective material arranged in a particular pattern on the given item.

18. The location system of claim 17, wherein the particular pattern on the given item includes first and second retroreflective points.

19. The location system of claim 15, wherein the light source is further configured to send messages via visible light communication.

20. The location system of claim 15, further comprising:
a wireless interface configured to send information indicative of the location of the first item to a computer system.
